(19) United States
(12) Patent Application Publication
(10) Pub. No.: US 2025/0150926 A1
(43) Pub. Date: May 8, 2025

(54) CONDITIONAL HANDOVER IN A NON-TERRESTRIAL WIRELESS NETWORK (NTN)

(71) Applicant: Apple Inc., Cupertino, CA (US)

(72) Inventors: Jie CUI, San Jose, CA (US); Qiming LI, Beijing (CN); Yang TANG, San Jose, CA (US); Dawei ZHANG, Saratoga, CA (US)

(73) Assignee: Apple Inc., Cupertino, CA (US)

(21) Appl. No.: 18/837,508

(22) PCT Filed: Feb. 10, 2022
(86) PCT No.: PCT/CN2022/075913

§ 371 Date: Aug. 9, 2024

(51) Int. Cl. H04W 36/36; H04W 36/08; H04W 36/30

(52) U.S. Cl. CPC H04W 36/362; H04W 36/08; H04W 36/30

(57) ABSTRACT

Mechanisms are provided for a user equipment (UE) to perform a handover operation from a first base station in a serving cell to a second base station in a target cell under conditions. The UE can receive a conditional handover instruction including a channel quality condition for the handover operation and an additional condition for the handover operation. The UE may determine an operation order between testing the channel quality condition and testing the additional condition, and further determine whether the channel quality condition or the additional condition is met or not. In response to a determination that the channel quality condition is met and a determination that the additional condition is met, the UE can perform the handover operation to handover the UE from the first base station to the second base station.

### FIELD

The described aspects generally relate to a non-terrestrial wireless network (NTN), including a conditional handover for a user equipment (UE) in the NTN.

### RELATED ART

A wireless communication system can include a fifth generation (5G) system, a New Radio (NR) system, a long term evolution (LTE) system, a combination thereof, or some other wireless systems. In addition, a wireless communication system can support a wide range of use cases such as enhanced mobile broad band (eMBB), massive machine type communications (mMTC), ultra-reliable and low-latency communications (URLLC), enhanced vehicle to anything communications (eV2X), among others. Enabling support for non-terrestrial networks (NTN) has been one direction under exploration in the Third Generation Partnership Project (3GPP).

### SUMMARY

Some aspects of this disclosure relate to apparatuses and methods for implementing conditional handover techniques for a user equipment (UE) to perform a handover operation from a first base station in a serving cell to a second base station in a target cell. The conditional handover can be indicated by a conditional handover instruction including a channel quality condition for the handover operation and an additional condition for the handover operation. The UE may determine an operation order between testing the channel quality condition and testing the additional condition, and further determine whether the channel quality condition or the additional condition is met or not. In response to a determination that the channel quality condition is met and a determination that the additional condition is met, the UE can perform the handover operation to handover the UE from the first base station to the second base station. The implemented techniques can be applicable to many wireless systems, e.g., a non-terrestrial wireless network (NTN), a wireless communication system based on 3rd Generation Partnership Project (3GPP) release 15 (Rel-15), release 16 (Rel-16), release 17 (Rel-17), or others.

Some aspects of this disclosure relate to a UE and a method performed by the UE. The UE can perform a method for conditional handover in a wireless communication network, such as a NTN. The method may include receiving a message including a conditional handover instruction to perform a handover operation from a first base station in a serving cell in a NTN to a second base station in a target cell in the NTN. The conditional handover instruction can include a channel quality condition for the handover operation and an additional condition for the handover operation. The method further includes determining an operation order between testing the channel quality condition and testing the additional condition. Accordingly, the method can include performing measurement operations to measure quality of a channel between the UE and the second base station in the target cell to test the channel quality condition, and determining whether the channel quality condition is met based on the measurement operations. In addition, the method may include determining whether the additional condition is met. In response to a determination that the channel quality condition is met and a determination that the additional condition is met, the method further includes performing the handover operation to handover the UE from the first base station to the second base station.

According to some aspects, the handover operation can include various operations such as starting a handover procedure for the UE, performing tracking of the target cell, and transmitting a message in a Random Access Channel from the UE to the second base station in the target cell.

According to some aspects, in response to a determination that the additional condition is not met, the UE can maintain a connection on a channel between the UE and the first base station in the serving cell. In some embodiments, the UE can receive a configuration from the first base station, where the configuration indicates the operation order between testing the channel quality condition and testing the additional condition. According to some aspects, the operation order can indicate that testing the channel quality condition is performed before testing the additional condition.

According to some aspects, the additional condition can be a time condition indicating a starting time T1 and an ending time T2 to perform the handover operation during a time range from T1 to T2. Accordingly, determining whether the additional condition is met comprises testing the starting time T1 is met and testing the ending time T2 is not exceeded. According to some aspects, the operation order can indicate testing the additional condition is performed before testing the channel quality condition, and the performing the measurement operations comprises performing the measurement operations based on the starting time T1 being met. In response to a determination that the ending time T2 is exceeded when performing the handover operation, maintaining connection on a channel between the UE and the first base station in the serving cell or quitting handover operation to perform Radio Resource Control (RRC) re-establishment.

According to some aspects, the operation order can indicate testing the additional condition is performed after testing the channel quality condition. Accordingly, the method further comprises, in response to the determination that the channel quality condition is met, performing, based starting time T1 being met, the handover operation to handover the UE from the first base station to the second base station.

According to some aspects, the additional condition can be a distance condition indicating at least a starting distance to perform the handover operation. In addition, the operation order can indicate testing the distance condition is performed before testing the channel quality condition. Accordingly, the determining whether the additional condition is met comprises performing a distance measurement to test whether the distance condition is met. In some embodiments, the performing the distance measurement comprises performing the distance measurement based on global navigation satellite systems (GNSS) information obtained in the NTN. Furthermore, the performing the measurement operations comprises performing the measurement operations after the performing the distance measurement.

According to some aspects, the additional condition can be a distance condition indicating at least a starting distance to perform the handover operation, and the operation order can indicate testing the additional condition is performed after testing the channel quality condition. Furthermore, the determining whether the additional condition is met comprises performing a distance measurement to test the distance condition is met after the performing measurement operations.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a non-terrestrial wireless network (NTN) including a user equipment (UE) to perform a conditional handover, according to some aspects of the disclosure.

FIG. 2 illustrates a block diagram of a UE implementing a conditional handover in an NTN, according to some aspects of the disclosure.

FIG. 3 illustrates an example process performed by a UE for performing a conditional handover in an NTN, according to some aspects of the disclosure.

FIGS. 4A-4H illustrate example processes performed by a UE for performing a conditional handover in an NTN, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

There are various wireless communication systems or networks. For example, a non-terrestrial wireless networks (NTN) is a wireless communication system. NTN can refer to any network that involves non-terrestrial flying objects. An NTN can include a satellite communication network, a high altitude platform systems (HAPS), an air-to-ground network, a low-altitude unmanned aerial vehicles (UAVs, aka. drones), or any other NTN network. Due to the relative movements of a user equipment (UE) or a satellite in an NTN, a UE can suffer from the Doppler frequency shift and lose synchronization with the base station. Conventionally, for wireless communication in an NTN, actions can be taken by the UE to overcome the Doppler frequency shift based on the global navigation satellite systems (GNSS) location of the UE.

When a UE of a wireless communication system moves from one location to another, the UE can be served by different base stations, e.g., a first base station, a second base station, a primary base station, a secondary base station, or a combination thereof. The procedure for when a UE is leaving a serving cell managed by a first base station and entering a target cell managed by a second base station can be referred to as a handover procedure or operation to handover the UE from the first base station to the second base station. The UE may perform measurement operations to measure quality of a channel between the UE and the second base station in the target cell to test whether a channel quality condition for the handover is met. For a normal handover operation, once the UE determines the channel quality condition is met based on the measurement operations, the handover operation can be performed. The handover operation may include various steps or operations, such as starting a handover procedure for the UE, performing tracking of the target cell, and transmitting a message in a Random Access Channel (RACH) from the UE to the second base station in the target cell.

For a conditional handover for the UE, the UE can receive a conditional handover (CHO) instruction or command to perform a handover operation from a first base station in a serving cell to a second base station in a target cell. An instruction or a command are used interchangeably in the current description. The conditional handover instruction can include a channel quality condition for the handover operation as for a normal handover instruction. Furthermore, an additional condition for the handover operation can be included in the conditional handover instruction as well. Embodiments herein presents various implementations for the conditional handover instruction.

In some embodiments, the UE can receive a message including a conditional handover instruction to perform a handover operation from a first base station in a serving cell to a second base station in a target cell. The conditional handover instruction can include a channel quality condition and an additional condition for the handover operation. The UE can determine an operation order between testing the channel quality condition and testing the additional condition. Afterwards, the UE can performing measurement operations to measure quality of a channel between the UE and the second base station in the target cell to test the channel quality condition, and determine whether the channel quality condition is met based on the measurement operations. In addition, the UE can determine whether the additional condition is met. When both the channel quality condition and the additional condition are met, the UE can perform the handover operation to handover the UE from the first base station to the second base station.

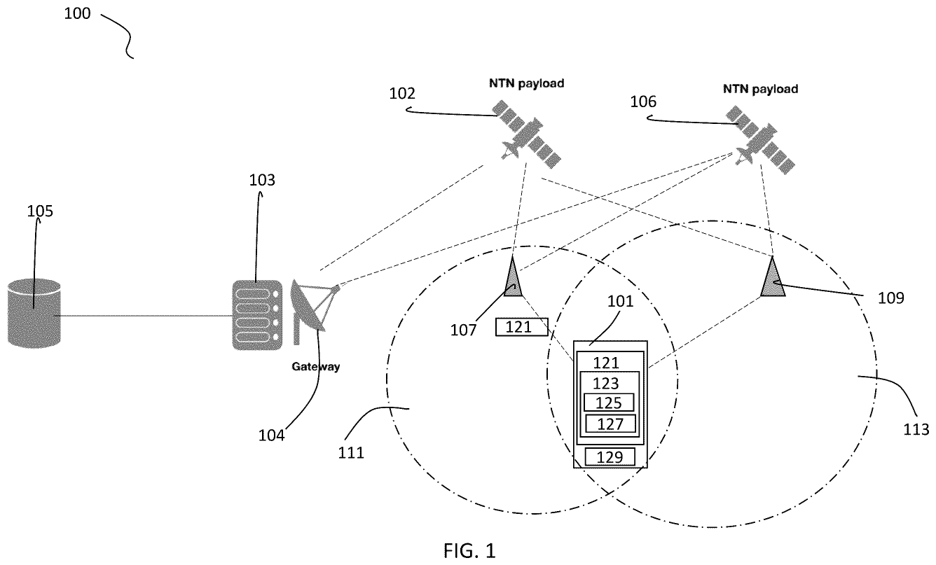

FIG. 1 illustrates an NTN 100 including a UE 101 to perform a conditional handover, according to some aspects of the disclosure. NTN 100 is provided for the purpose of illustration only and does not limit the disclosed aspects.

NTN 100 can include, but is not limited to, UE 101, a base station 107 in a serving cell 111, a base station 109 in a target cell 113. One or more satellite, e.g., a satellite 102 and a satellite 106, can be in communication with base station 107 and base station 109, and in communication with UE 101 through base station 107 or base station 109. Satellite 102 and satellite 106 can communicate with a gateway 104, a base station 103, and a core network 105. Satellite 102 and satellite 106 can include a network node or a transceiver for wireless communication.

There can be various implementations of NTN 100. For example, base station 103 and gateway 104 may be integrated into one unit instead of being separated components. Base station 103 and core network 105 may implement functions as a normal terrestrial wireless network without a satellite, while gateway 104 may implementation functions between a terrestrial wireless network and satellite 102 or satellite 106.

In some embodiments, NTN 100 can have a transparent payload, where base station 103 is located on the ground. In some embodiments, NTN 100 can have a regenerative payload when base station 103 can be located on satellite 102 or satellite 106. There can be multiple satellites with onboard base stations communicating with each other, e.g., communication between satellite 102 and satellite 106. There can be other network entities, e.g., network controller, a relay station, not shown. An NTN can be referred to as a wireless network, a wireless communication system, or some other names known to a person having ordinary skill in the art. Techniques disclosed for embodiments herein can be applicable to many other wireless communication systems or networks.

In some embodiments, NTN 100 can be an NTN having a non-terrestrial flying object, e.g., satellite 102 or satellite 106. In some embodiments, NTN 100 can include a satellite communication network that includes one satellite, e.g., satellite 102, a HAPS, or an air-to-ground network, or a UAV. Satellite 102 or satellite 106 can be a low Earth orbiting (LEO) satellite, a medium Earth orbiting (MEO) satellite, or a geosynchronous Earth orbiting (GEO) satellite. NTN 100 can be a HAPS, which can be an airborne platform including airplanes, balloons, and airships. For example, NTN 100 can include the International Mobile Telecommunications base stations, known as HIBS. A HIBS system can provides mobile service in the same transmission frequencies used by terrestrial mobile networks. NTN 100 can be an air-to-ground network to provide in-flight connectivity for airplanes by utilizing ground stations which play a similar role as base stations in terrestrial mobile networks. NTN 100 can also be a mobile enabled low-altitude UAVs.

In some examples, NTN 100 can be a wireless system including different wireless technologies, e.g., NR, LTE, 5G, some other wireless technology, or a combination thereof. NTN 100 can support a wide range of use cases such as enhanced mobile broad band (eMBB), massive machine type communications (mMTC), ultra-reliable and low-latency communications (URLLC), and enhanced vehicle to anything communications (eV2X).

In some embodiments, satellite 102 or satellite 106 can be a GEO satellite deployed at an altitude of 35786 Km and is characterized by a slow motion around its orbital position with respect to a point on the Earth. Compared to terrestrial cellular systems, communication networks based on a GEO satellite have a large propagation delay that has to be taken into account in the overall design of the satellite network and high propagation losses. Additionally and alternatively, satellite 102 or satellite 106 can be a LEO satellite at an altitude of 300-3000 km. As a consequence, satellite 102 or satellite 106 can have a lower propagation delay, lower propagation losses and a higher Doppler frequency shift than a GEO satellite.

According to some aspects, base station 103, base station 107, or base station 109 can be a fixed station or a mobile station. In some embodiments, base station 103 can be located onboard satellite 102 or satellite 106. Base station 103, base station 107, or base station 109 can also be called other names, such as a base transceiver system (BTS), an access point (AP), a transmission/reception point (TRP), an evolved NodeB (eNB), a next generation node B (gNB), a 5G node B (NB), or some other equivalent terminology.

According to some aspects, UE 101 can be stationary or mobile. UE 101 can be a handheld terminal or a very small aperture terminal (VSAT) that is equipped with parabolic antennas and typically mounted on buildings or vehicles. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, due to the relative movement of UE 101 and satellite 102 or satellite 106, UE 101 can suffer from the Doppler frequency shift. Doppler frequency shift needs to be compensated in satellite communication. Dynamic Doppler compensation, where the frequency of a signal is changed progressively during transmission, is used so that the satellite receives a constant frequency signal. Dynamic Doppler compensation for the Doppler frequency shift can be calculated based on the location, e.g., GNSS location, of UE 101.

According to some aspects, base station 107 manages serving cell 111, and base station 109 manages target cell 113. In some examples, base station 107 can be a first primary base station, and serving cell 111 can be a first primary cell (PCell); base station 109 can be a second primary base station, and target cell 113 can be a second PCell. In some other examples, a primary base station can be referred to as other names known to one having ordinary skills in the art. Initially, UE 101 can communicate with base station 107. When UE 101 moves along towards target cell 113, UE 101 may perform a handover procedure to communicate with base station 109 to replace base station 107. During the handover operation, UE 101 can establish dual connectivity in serving cell 111 to communicate with base station 107, and in target cell 113 to communicate with base station 109.

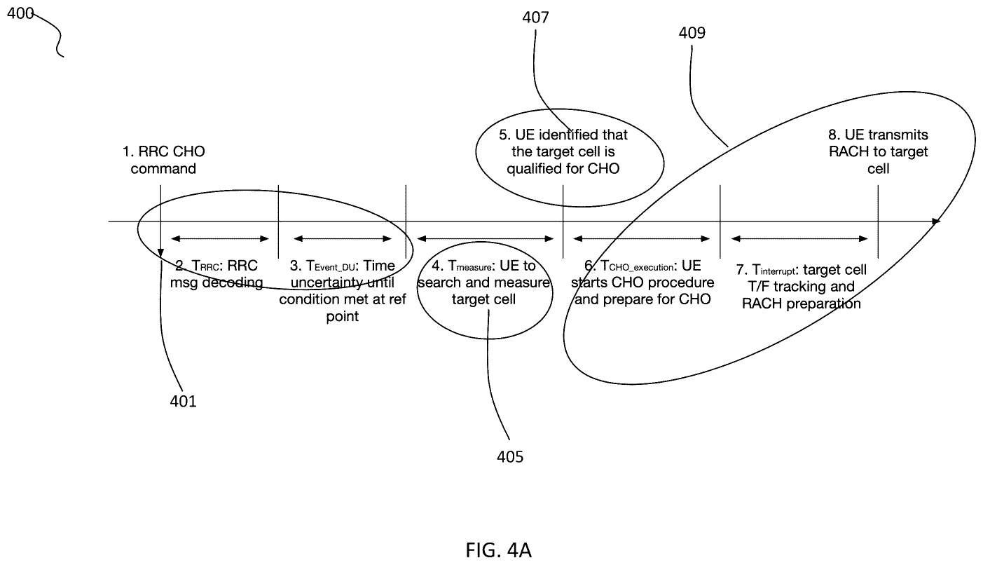

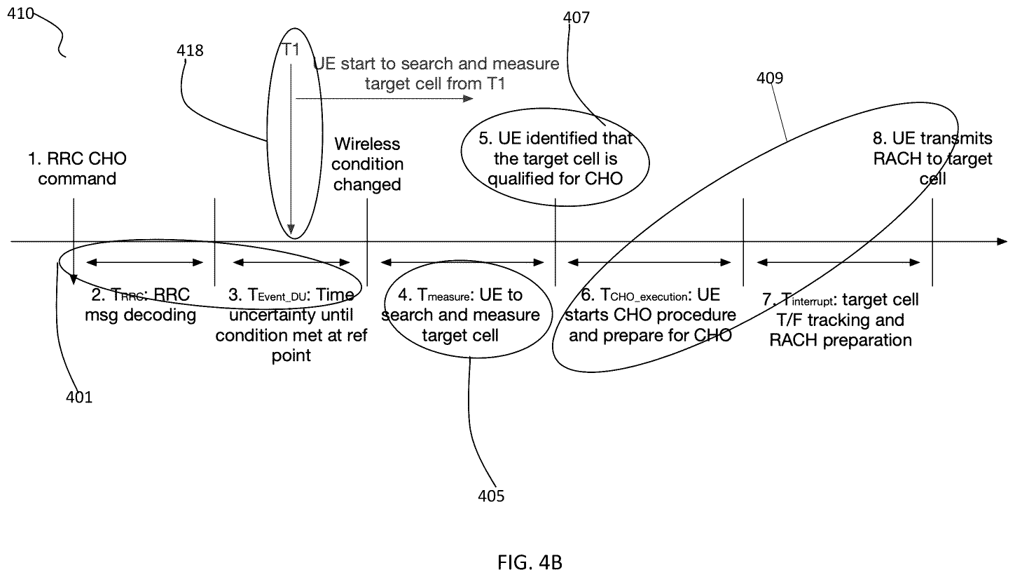

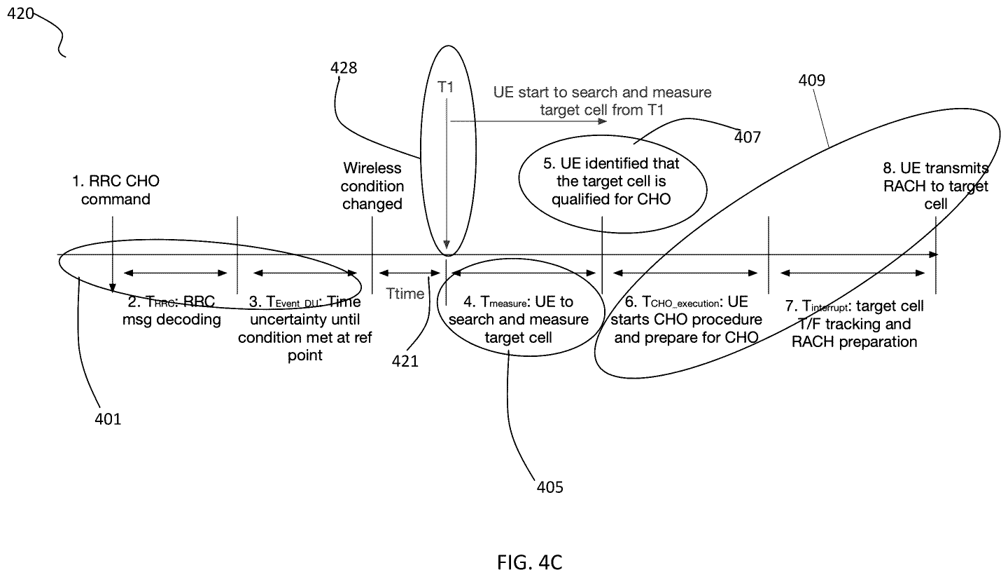

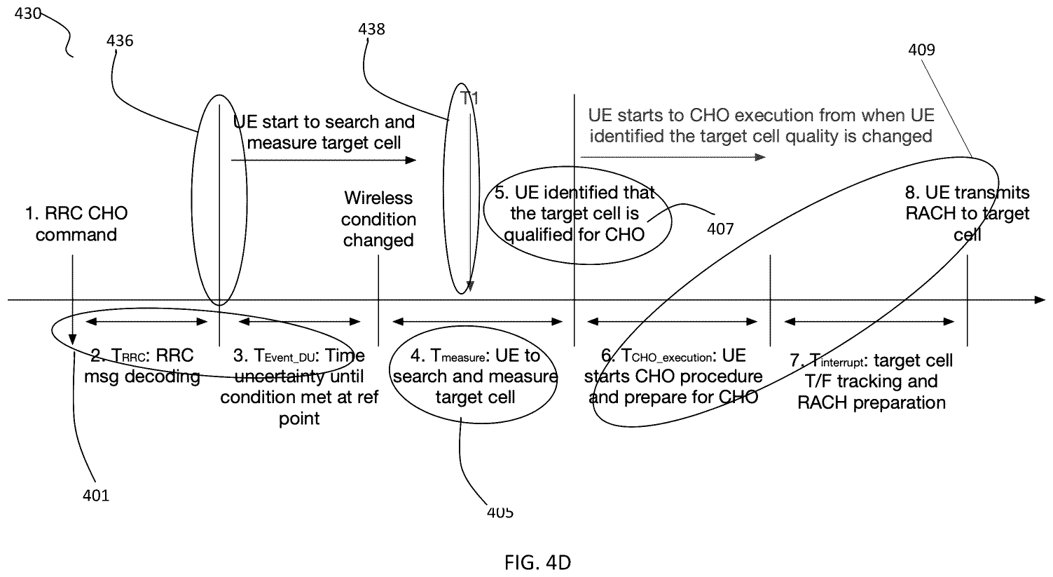

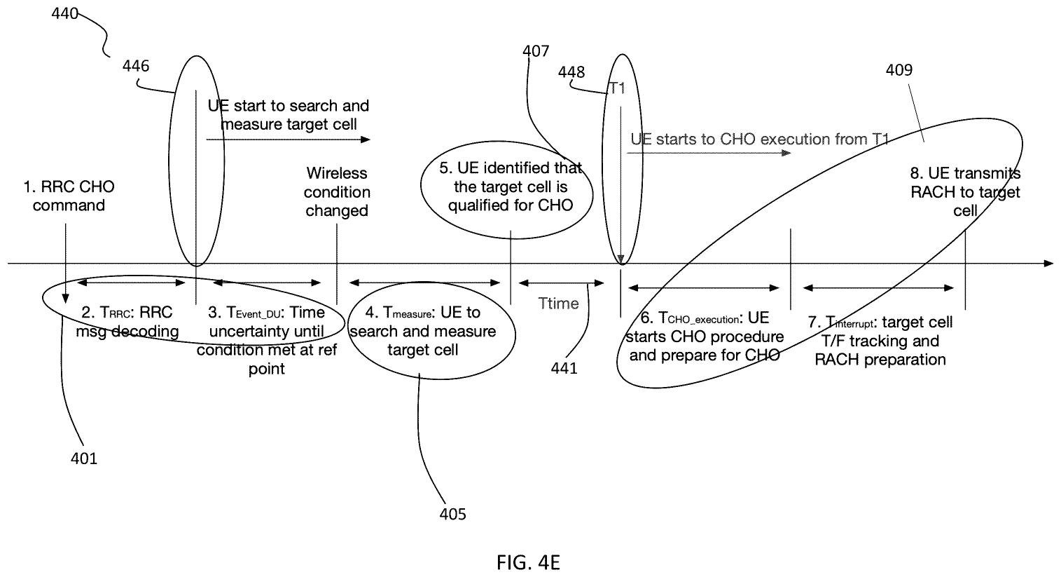

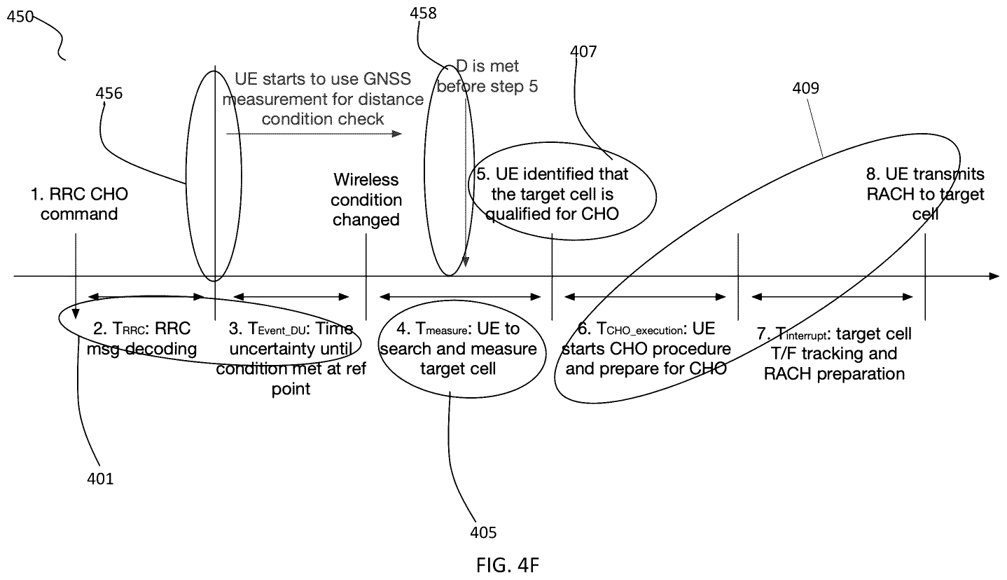

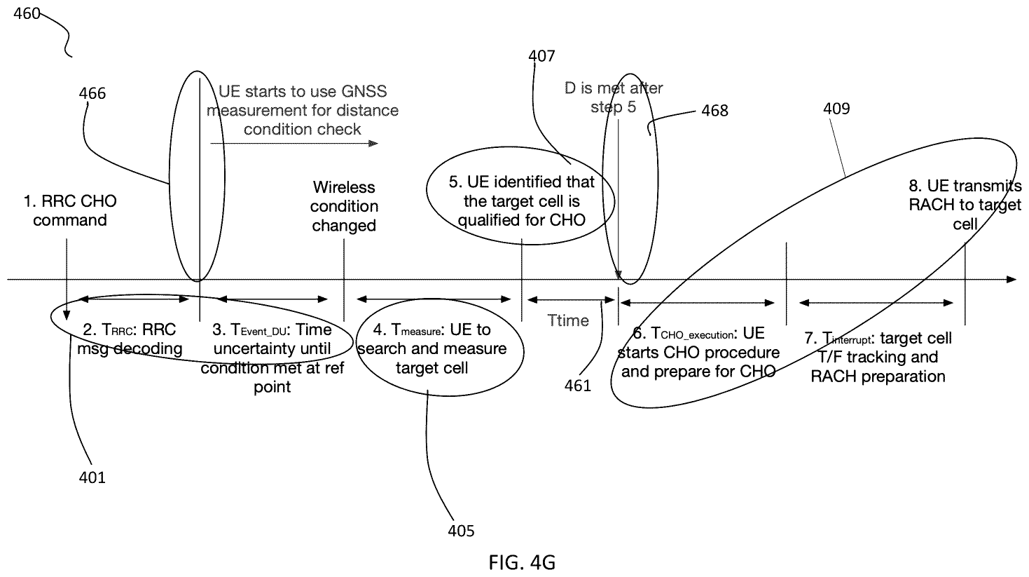

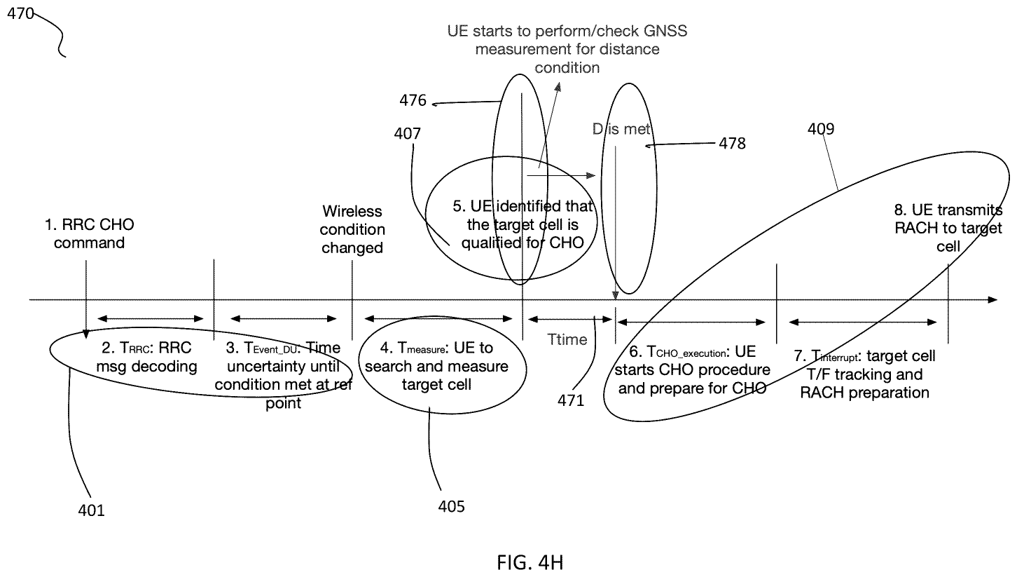

According to some aspects, UE 101 can receive a message 121 from base station 107. Message 121 can include a conditional handover instruction 123 to perform a handover operation from base station 107 in serving cell 111 to base station 109 in target cell 113. Conditional handover instruction 123 can include a channel quality condition 125 for the handover operation and an additional condition 127 for the handover operation. Based on the conditional handover instruction 123, UE 101 can determine an operation order between testing the channel quality condition 125 and testing the additional condition 127. In some embodiments, the operation order between testing the channel quality condition 125 and testing the additional condition 127 can be a sequential order, where testing the channel quality condition 125 is performed before testing the additional condition 127. In some other embodiments, testing the channel quality condition 125 can be performed in parallel with testing the additional condition 127. Therefore, operations for testing the channel quality condition 125 and operations for testing the additional condition 127 can be performed in parallel or in a pipelined fashion, as shown in FIG. 4G. In some embodiments, UB 101 can receive a configuration 129 from base station 107, where configuration 129 can indicate the operation order between testing the channel quality condition 125 and testing the additional condition 127.

According to some aspects, UE 101 can perform measurement operations to measure quality of a channel between UE 101 and base station 109 in target cell 113 to test the channel quality condition 125, UE 101 can further determine whether the channel quality condition 125 is met based on the measurement operations. UE 101 can further determine whether the additional condition 127 is met. In response to a determination that the channel quality condition 125 is met and a determination that the additional condition 127 is met, UE 101 can perform the handover operation to handover UE 101 from base station 107 to base station 109. According to some aspects, the handover operation can include various operations such as starting a handover procedure for UE 101, performing tracking of target cell 113, and transmitting a message in a Random Access Channel (RACH) from UE 101 to base station 109 in target cell 113.

According to some aspects, in response to a determination that the additional condition 127 is not met, UE 101 can maintain connection on a channel between UE 101 and base station 107 in serving cell 111. According to some aspects, the operation order can indicate that testing the channel quality condition 125 is performed before testing the additional condition 127.

According to some aspects, the additional condition 127 can be a time condition indicating a starting time T1 and an ending time T2 to perform the handover operation during a time range from T1 to T2. Accordingly, the conditional handover may not be carried out before T1, which represents the earliest point in time when UE 101 can perform CHO to the target cell. Similarly, the conditional handover may not be carried out after T2, which represents the end of the time window. Accordingly, UE 101 can determine that the additional condition 127 is met when the starting time T1 is met. When the operation order indicates that testing the additional condition 127 is performed before testing the channel quality condition 125, UE 101 can perform the measurement operations of the channel between UE 101 and base station 109 in target cell 113 based on the starting time T1 being met.

According to some aspects, when the operation order indicates testing the additional condition 127 is performed after testing the channel quality condition 125, in response to the determination that the channel quality condition 125 is met, UE 101 can perform, based starting time T1 being met, the handover operation to handover UE 101 from base station 107 to base station 109.

According to some aspects, the additional condition 127 can be a distance condition indicating at least a starting distance to perform the handover operation. In addition, the operation order can indicate testing the distance condition is performed before testing the channel quality condition 125. Accordingly, UE 101 can perform a distance measurement to test whether the distance condition is met. In some embodiments, UE 101 can perform the distance measurement based on GNSS information. Furthermore, UE 101 can perform the measurement operations for the channel between UE 101 and base station 109 after performing the distance measurement.

According to some aspects, the additional condition 127 can be a distance condition indicating at least a starting distance to perform the handover operation, and the operation order can indicate testing the additional condition 127 is performed after testing the channel quality condition 125. Furthermore, UE 101 can perform a distance measurement to test the distance condition is met after the performing measurement operations.

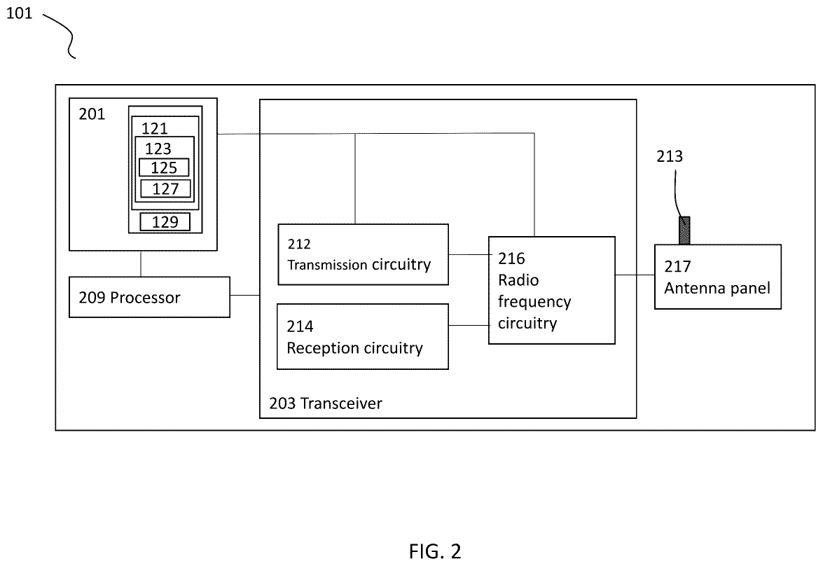

According to some aspects, UE 101 can be implemented according to a block diagram as illustrated in FIG. 2. Referring to FIG. 2, UE 101 can have antenna panel 217 including one or more antenna elements to form various transmission beams, e.g., transmission beam 213, coupled to a transceiver 203 and controlled by a processor 209. Transceiver 203 and antenna panel 217 (using transmission beam 213) can be configured to enable wireless communication in a wireless network. In detail, transceiver 203 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 209 can be communicatively coupled to a memory 201, which are further coupled to the transceiver 203. Various data can be stored in memory 201. In some examples, memory 201 can store message 121, handover instruction 123, the channel quality condition 125, the additional condition 127, and configuration 129 indicating the operation order between testing the channel quality condition 125 and testing the additional condition 127.

In some embodiments, memory 201 can include instructions, that when executed by the processor 209 perform operations described herein, e.g., operations to perform a conditional handover for UE 101. Alternatively, the processor 209 can be “hard-coded” to perform the operations described herein.

In some embodiments, processor 209 can be configured to receive message 121 including conditional handover instruction 123 to perform a handover operation from base station 107 in serving cell 111 to base station 109 in target cell 113. Processor 209 can be further configured to determine an operation order between testing the channel quality condition 125 and testing the additional condition 127. Processor 209 can be further configured to perform measurement operations to measure quality of the channel between UE 101 and base station 109 in target cell 113 to test the channel quality condition 125, and determine whether the channel quality condition 125 is met based on the measurement operations. In addition, processor 209 can be configured to determine whether the additional condition 127 is met. In response to a determination that the channel quality condition 125 is met and a determination that the additional condition 127 is met, processor 209 can be configured to perform the handover operation to handover UE 101 from base station 107 to base station 109.

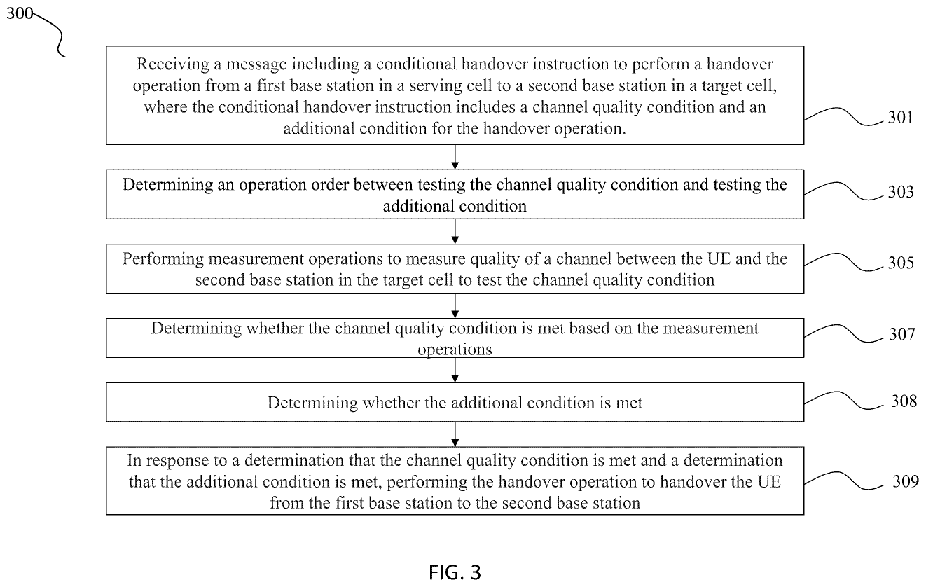

FIG. 3 illustrates an example process 300 for a UE for performing a conditional handover in an NTN, according to some aspects of the disclosure. According to some aspects, process 300 can be performed by UE 101.

At 301, UE 101 can receive a message including a conditional handover instruction to perform a handover operation from a first base station in a serving cell to a second base station in a target cell, where the conditional handover instruction includes a channel quality condition for the handover operation and an additional condition for the handover operation. For example, as shown in FIG. 1, UE 101 can receive message 121 including conditional handover instruction 123 to perform a handover operation from base station 107 in serving cell 111 to base station 109 in target cell 113, where conditional handover instruction 123 includes the channel quality condition 125 and the additional condition 127 for the handover operation.

At 303, UE 101 can determine an operation order between testing the channel quality condition and testing the additional condition. For example, as shown in FIG. 1, UE 101 can determine an operation order between testing the channel quality condition 125 and testing the additional condition 127.

At 305, UE 101 can perform measurement operations to measure quality of a channel between the UE and the second base station in the target cell to test the channel quality condition. For example, as shown in FIG. 1, UE 101 can perform measurement operations to measure quality of a channel between UE 101 and base station 109 in the target cell 113 to test the channel quality condition 125.

At 307, UE 101 can determine whether the channel quality condition is met based on the measurement operations. For example, as shown in FIG. 1, UE 101 can determine whether the channel quality condition 125 is met based on the measurement operations.

At 308, UE 101 can determine whether the additional condition is met. For example, as shown in FIG. 1, UE 101 can determine whether the additional condition 127 is met. As will be discussed in reference to FIG. 4B-4H, in some embodiments, step 308 can be performed before step 307, so that the additional condition is determined to be met before the channel condition is determined to be met.

At 309, in response to a determination that the channel quality condition is met and a determination that the additional condition is met, UE 101 can perform the handover operation to handover the UE from the first base station to the second base station. For example, as shown in FIG. 1, in response to a determination that the channel quality condition 125 is met and a determination that the additional condition 127 is met, UE 101 can perform the handover operation to handover UE 101 from base station 107 to base station 109.

FIGS. 4A-4H illustrate example processes 400, 410, 420, 430, 440, 450, 460, and 470 for a conditional handover process in a wireless network or an NTN, according to some aspects of the disclosure. Process 400 is a partial process to illustrate the shared operations among processes 410, 420, 430, 440, 450, 460, and 470. Processes 410, 420, 430, 440, 450, 460, and 470 can be examples of process 300, illustrated with more, less, or different details, which can be performed by UE 101.

As show in FIG. 4A, process 400 includes shared operations among processes 410, 420, 430, 440, 450, 460, and 470. More specifically, only the channel quality condition for the handover operation is described in FIG. 4A. The implementation of the additional condition for the handover operation is not described in FIG. 4A, but is described in FIGS. 4B-4H.

At 401, at step 1, a UE 101 receives a CHO command or a conditional handover instruction in a Radio Resource Control (RRC) message; at step 2: the UE decodes the CHO command contained in the RRC message and starts to monitor a channel between UE 101 and base station 109 in the target cell 113. At step 3, the channel condition for the channel between UE 101 and base station 109 in the target cell 113 can be changed, e.g., the channel quality at the channel is improved. UE 101 may not perform any operations at step 3. Instead, UE 101 may just wait for the wireless channel condition change. Operations performed at 401 can be an example of operations performed at 301.

At 405, at step 4, UE 101 can perform cell searching and measuring on the target cell 113. Various detailed steps can be performed at 405. For example, UE 101 can perform measurement operations to measure quality of a channel between UE 101 and base station 109 in the target cell 113 to test the channel quality condition. Operations performed at 405 can be an example of operations performed at 305.

At 407, at step 5, based on the cell measurement results, UE 101 can determine that the quality of the channel between UE 101 and base station 109 is above the threshold for CHO, where the threshold can be an example of the channel quality condition 125. Operations performed at 407 can be an example of operations performed at 307.

At 409, UE 101 can trigger the handover operation. In detail, at step 6, UE 101 can start CHO procedure and prepare the hardware and/or software for CHO; at step 7, after preparation, UE 101 can perform physical layer time/frequency tracking and RACH preparation for the target cell 113. Afterwards, at step 8, UE 101 can successfully transmit RACH to base station 109 in the target cell 113 and CHO is completed at UE 101. In some embodiments, some additional steps for UE 101 and network are to be completed for the RACH, which are not described in detail herein. Operations performed at 409 can be an example of operations performed at 309.

FIG. 4A also shows a timeline for the conditional handover operation. The timeline for the conditional handover D_{CHO} can be defined as the time between the end of the last Transmission Time Interval (TTI) containing the RRC message that includes the conditional handover command and the start the transmission of the new uplink PRACH, which can be expressed as follows:

$${D}_{CHO} = {T}_{RRC} + {T}_{Event \_ DU} + [ {T}_{measure} ] + {T}_{CHO \_ execution} + {T}_{interrupt} ,$$

where T_{RRC} is the RRC procedure delay at step 2; T_{Event_DU} is the delay uncertainty at step 3; Tₘₑₐₛᵤᵣₑ is the measurements time delay at step 4 of 405; T_{CHO_execution} is the time at step 6 for UE execution preparation time for conditional handover; Tᵢₙₜₑᵣᵣᵤₚₜ is the delay at step 7, which is the time between when UE 101 starts to execute the conditional handover to the target cell 113 and the time UE 101 starts transmission of the new PRACH.

Process 400 only implements the channel quality condition for the conditional handover operation. The implementation of the additional condition for the handover operation are described in FIGS. 4B-4H by processes 410, 420, 430, 440, 450, 460, and 470. Processes 410, 420, 430, 440, 450, 460, and 470 contain the operations 401, 405, 407, and 409 as shown in FIG. 4A, but are not repeated in the following discussion in the interest of brevity. Additional operations shown in FIGS. 4B-4H are further described.

As show in FIG. 4B, process 410 can be an example of process 300 for performing a conditional handover based on a conditional handover instruction including a channel quality condition and an additional condition. The additional condition for process 410 is a time condition indicating a starting time T1 and an ending time T2 to perform the handover operation during a time range from T1 to T2. Determining whether the additional condition is met comprises testing the starting time T1 is met, and testing the ending time T2 is not exceeded.

Even though not shown, based on operations at 303, UE 101 can determine an operation order to test the channel quality condition after testing the time condition. At operation 418, UE 101 can determine that the starting time T1 of the time condition is met, and is earlier than the wireless condition change at the end of step 3. Operation 418 can be an example of operations performed at 308. Accordingly, operations performed at 405, e.g., the measurement operations, can be performed based on the starting time T1 being met at operation 418. Operations at 405 are performed after the starting time T1 being met at operation 418. In response to a determination that the ending time T2 is exceeded when performing the handover operation, maintaining connection on a channel between the UE and the first base station in the serving cell or quitting handover operation to perform RRC re-establishment.

As show in FIG. 4C, process 420 can be an example of process 300 for performing a conditional handover based on a conditional handover instruction including a channel quality condition and an additional condition. The additional condition for process 420 is a time condition indicating a starting time T1 and an ending time T2 to perform the handover operation during a time range from T1 to T2. Determining whether the additional condition is met comprises testing the starting time T1 is met, and testing the ending time T2 is not exceeded.

Even though not shown, based on operations at 303, UE 101 can determine an operation order to test the channel quality condition after testing the time condition. At operation 428, UE 101 can determine that the starting time T1 of the time condition is met. In this case, the starting time T1 is met after a time interval 421 following the end of step 3. Hence, when the channel is improved in quality at the end of step 3, but the starting time T1 is not met yet, UE 101 can wait after a time interval 421 till the starting time T1 is met at operation 428. Operation 428 can be an example of operations performed at 308. UE 101 can determine whether the starting time T1 is met or not by a timer. Furthermore, operations performed at 405, e.g., the measurement operations, can be performed based on the starting time T1 being met at operation 428. In response to a determination that the ending time T2 is exceeded when performing the handover operation, maintaining connection on a channel between the UE and the first base station in the serving cell or quitting handover operation to perform RRC re-establishment.

As show in FIG. 4D, process 430 can be an example of process 300 for performing a conditional handover based on a conditional handover instruction including a channel quality condition and an additional condition. The additional condition for process 430 is a time condition indicating a starting time T1 and an ending time T2 to perform the handover operation during a time range from T1 to T2. Determining whether the additional condition is met comprises testing the starting time T1 is met, and testing the ending time T2 is not exceeded.

Even though not shown, based on operations at 303, UE 101 can determine an operation order to test the channel quality condition before testing the time condition. At 436, after the RRC message is decoded at step 2, UE 101 can start to search and measure the channel quality for the channel between UE 101 and base station 109. Operation 436 can be optional. Additionally and alternatively, UE 101 can start search and measure the channel quality for the channel at step 4 for operations at 405. At 438, UE 101 can determine that the starting time T1 of the time condition is met, and is earlier than the end of operations for step 4 at 405. Operation 438 can be an example of operations performed at 308. Accordingly, operations at 405 are performed before the starting time T1 being met at operation 438. In response to a determination that the ending time T2 is exceeded when performing the handover operation, maintaining connection on a channel between the UE and the first base station in the serving cell or quitting handover operation to perform RRC re-establishment.

As show in FIG. 4E, process 440 can be an example of process 300 for performing a conditional handover based on a conditional handover instruction including a channel quality condition and an additional condition. The additional condition for process 440 is a time condition indicating a starting time T1 and an ending time T2 to perform the handover operation during a time range from T1 to T2. Determining whether the additional condition is met comprises testing the starting time T1 is met, and testing the ending time T2 is not exceeded.

Even though not shown, based on operations at 303, UE 101 can determine an operation order to test the channel quality condition before testing the time condition. At 446, after the RRC message is decoded at step 2, UE 101 can start to search and measure the channel quality for the channel between UE 101 and base station 109. Operation 446 can be optional. Additionally and alternatively, UE 101 can start search and measure the channel quality for the channel at step 4 for operations at 405. At 448, UE 101 can determine that the starting time T1 of the time condition is met, and is after the end of operations for step 4 at 405. There is a time interval 441 between the end of operations for step 4 at 405, and operations at 448. Operation 448 can be an example of operations performed at 308. Accordingly, operations at 405 are performed before the starting time T1 being met at operation 448. In response to a determination that the ending time T2 is exceeded when performing the handover operation, maintaining connection on a channel between the UE and the first base station in the serving cell or quitting handover operation to perform RRC re-establishment.

In some embodiments, UE 101 can determine an operation order between testing the channel quality condition and testing the time condition based on a network configuration or indication. Base station 107 can configure the operation order between testing the channel quality condition and testing the time condition. The network indication could be satellite specific. For example, a first configuration for the operation order can be used when base station 107 and base station 109 are in communication with satellite 102, and a second configuration for the operation order different from the first configuration can be used when base station 107 and base station 109 are in communication with satellite 106. In some embodiments, the configuration for the operation order may depend on whether satellite 102 is a LEO satellite or a GEO satellite. The configuration for the operation order from the network could be carried in the conditional handover instruction or command, or other dedicated RRC signaling or a system information (SI).

In some embodiments, when the conditional handover instruction includes an additional condition as a time condition indicating a starting time T1 and an ending time T2 to perform the handover operation during a time range from T1 to T2, there may be various limitations on the ending time T2. In some embodiments, T2 may be designed to be no earlier than the timing point when UE 101 has identified the target cell quality is changed at the end of step 3, or no earlier than the starting of CHO execution/preparation at step 6. If T2 does not meet the conditions, UE 101 may drop the conditional handover instruction, and start RRC reestablishment with base station 107. In some embodiments, UE 101 may fallback to the channel between UE 101 and base station 107 in the original serving cell 111 and restart the CHO procedure.

As show in FIG. 4F, process 450 can be an example of process 300 for performing a conditional handover based on a conditional handover instruction including a channel quality condition and an additional condition. The additional condition for process 450 is a distance condition indicating at least a starting distance to perform the handover operation. Determining whether the additional condition is met comprises performing a distance measurement to test whether the distance condition is met, e.g., performing the distance measurement based on GNSS information obtained in the NTN.

Even though not shown, based on operations at 303, UE 101 can determine an operation order to test the distance condition before testing the channel quality condition. At 456, after the RRC message is decoded at step 2, UE 101 can start to perform the distance measurement based on GNSS information. At 458, UE 101 can determine the distance condition is met. UE 101 determines the distance condition is met before operations for step 4 at 405 is finished. Accordingly, UE 101 can finish operations for step 4 at 405 to perform the measurement operations to test the channel quality condition is met or not. UE 101 can perform the measurement operations after determining the distance condition is met.

As show in FIG. 4G, process 460 can be an example of process 300 for performing a conditional handover based on a conditional handover instruction including a channel quality condition and an additional condition. The additional condition for process 460 is a distance condition indicating at least a starting distance to perform the handover operation. Determining whether the additional condition is met comprises performing a distance measurement to test whether the distance condition is met, e.g., performing the distance measurement based on GNSS information obtained in the NTN.

Even though not shown, based on operations at 303, UE 101 can determine an operation order to test the distance condition before testing the channel quality condition. At 466, after the RRC message is decoded at step 2, UE 101 can start to perform the distance measurement based on GNSS information. At 468, UE 101 can determine the distance condition is met. UE 101 can perform measurement operations to measure quality of a channel between the UE and the second base station in the target cell to test the channel quality condition after operations at 468. Additionally and alternatively, as shown in FIG. 4G, UE 101 can perform measurement operations to measure quality of a channel to test the channel quality condition in parallel with performing the distance measurement based on GNSS information. In some embodiments, UE 101 can determine the distance condition is met at 468 after the operations for step 4 at 405 is finished. After finishing operations for step 4 at 405 to determine the channel quality condition is met, UE 101 can wait for a time interval 461 to determine the distance condition is met at 468.

As show in FIG. 4H, process 470 can be an example of process 300 for performing a conditional handover based on a conditional handover instruction including a channel quality condition and an additional condition. The additional condition for process 470 is a distance condition indicating at least a starting distance to perform the handover operation. Determining whether the additional condition is met comprises performing a distance measurement to test whether the distance condition is met, e.g., performing the distance measurement based on GNSS information obtained in the NTN.

Even though not shown, based on operations at 303, UE 101 can determine an operation order to test the distance condition after testing the channel quality condition. At 476, which is shown as the same time instance for operations at 407, UE 101 can start to perform the distance measurement based on GNSS information. At 478, UE 101 can determine the distance condition is met. UE 101 determines the distance condition is met after operations for step 4 at 405 is finished. A time interval 471 can separate the end of operations at 407 and operations at 478. Accordingly, UE 101 can finish operations for testing the distance condition at 478 after the time interval 471 following the operations at 407 determining the channel quality condition is met based on the measurement operations. UE 101 can perform a distance measurement to test the distance condition is met after determining the channel quality condition is met.

In some embodiments, UE 101 can determine an operation order between testing the channel quality condition and testing the distance condition based on a network configuration or indication. Base station 107 can configure the operation order between testing the channel quality condition and testing the distance condition. The network indication could be satellite specific. For example, a first configuration for the operation order can be used when base station 107 and base station 109 are in communication with satellite 102, and a second configuration for the operation order different from the first configuration can be used when base station 107 and base station 109 are in communication with satellite 106. In some embodiments, the configuration for the operation order may depend on whether satellite 102 is a LEO satellite or a GEO satellite. The configuration for the operation order from the network could be carried in the conditional handover instruction or command, or other dedicated RRC signaling or a SI.

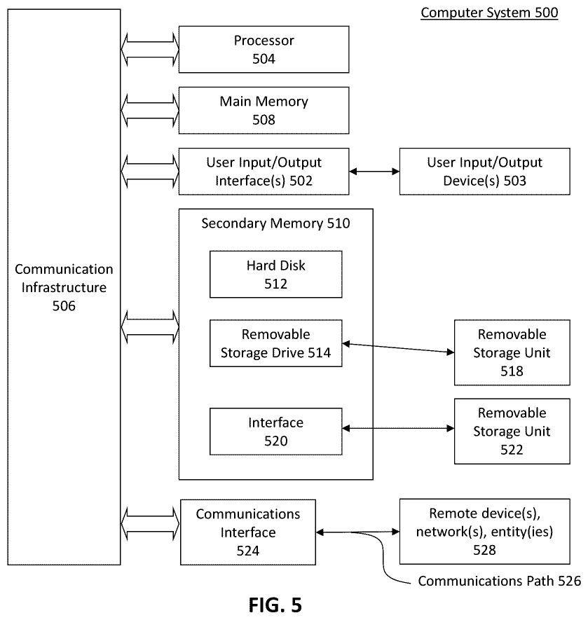

Various aspects can be implemented, for example, using one or more computer systems, such as computer system 500 shown in FIG. 5. Computer system 500 can be any computer capable of performing the functions described herein such as UE 101, base station 103, base station 107, or base station 109, as shown in FIG. 1 and FIG. 2, for operations described for processor 209 or process 300, process 400, processes 410-470 as shown in FIGS. 3, 4A-4H. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103, base station 107, or base station 109, as shown in FIG. 1 and FIG. 2. In some examples, the operations include those operations illustrated and described for process 300, process 400, processes 410-470 as shown in FIGS. 3, 4A-4H.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE), comprising:
receiving a message including a conditional handover instruction to perform a handover operation from a first base station in a serving cell to a second base station in a target cell, wherein the conditional handover instruction includes a channel quality condition for the handover operation and an additional condition for the handover operation, and wherein the first base station and the second base station are in a non-terrestrial wireless network (NTN);
determining an operation order between testing the channel quality condition and testing the additional condition;
performing measurement operations to measure quality of a channel between the UE and the second base station in the target cell to test the channel quality condition;
determining whether the channel quality condition is met based on the measurement operations;
determining whether the additional condition is met; and
in response to a determination that the channel quality condition is met and a determination that the additional condition is met, performing the handover operation to handover the UE from the first base station to the second base station.

2. The method of claim 1, wherein the operation order indicates testing the channel quality condition is performed before testing the additional condition.

3. The method of claim 1, wherein the additional condition is a time condition indicating a starting time T1 and an ending time T2 to perform the handover operation during a time range from T1 to T2, and
the determining whether the additional condition is met comprises testing the starting time T1 is met and testing the ending time T2 is not exceeded.

4. The method of claim 3, further comprising:
in response to a determination that the ending time T2 is exceeded when performing the handover operation, maintaining connection on a channel between the UE and the first base station in the serving cell or quitting handover operation to perform Radio Resource Control (RRC) re-establishment.

5. The method of claim 3, wherein the operation order indicates testing the additional condition is performed before testing the channel quality condition, and the performing the measurement operations comprises performing the measurement operations based on the starting time T1 being met.

6. The method of claim 3, wherein the operation order indicates testing the additional condition is performed after testing the channel quality condition, and the method further comprises:
in response to the determination that the channel quality condition is met, performing, based starting time T1 being met, the handover operation to handover the UE from the first base station to the second base station.

7. The method of claim 1, further comprising:
in response to a determination that the additional condition is not met, maintaining connection on a channel between the UE and the first base station in the serving cell.

8. The method of claim 1, further comprising:
receiving a configuration from the first base station, wherein the configuration indicates the operation order between testing the channel quality condition and testing the additional condition.

9. The method of claim 1, wherein the additional condition is a distance condition indicating at least a starting distance to perform the handover operation,
the operation order indicates testing the distance condition is performed before testing the channel quality condition,
the determining whether the additional condition is met comprises performing a distance measurement to test whether the distance condition is met, and
the performing the measurement operations comprises performing the measurement operations after determining the distance condition is met.

10. The method of claim 1, wherein the additional condition is a distance condition indicating at least a starting distance to perform the handover operation,
the operation order indicates testing the distance condition is performed after testing the channel quality condition, and
the determining whether the additional condition is met comprises performing a distance measurement to test the distance condition is met after determining the channel quality condition is met.

11. A user equipment (UE), comprising:
a transceiver configured to enable wireless communication in a non-terrestrial wireless network (NTN); and
a processor communicatively coupled to the transceiver and configured to:
receive a message including a conditional handover instruction to perform a handover operation from a first base station in a serving cell to a second base station in a target cell, wherein the conditional handover instruction includes a channel quality condition for the handover operation and an additional condition for the handover operation, and wherein the first base station and the second base station are in the NTN;
determine an operation order between testing the channel quality condition and testing the additional condition;
perform measurement operations to measure quality of a channel between the UE and the second base station in the target cell to test the channel quality condition;
determine whether the channel quality condition is met based on the measurement operations;
determine whether the additional condition is met; and
in response to a determination that the channel quality condition is met and a determination that the additional condition is met, perform the handover operation to handover the UE from the first base station to the second base station.

12. The UE of claim 11, wherein the additional condition is a time condition indicating a starting time T1 and an ending time T2 to perform the handover operation during a time range from T1 to T2, and wherein the processor is further configured to determine whether the additional condition is met by testing the starting time T1 is met and testing the ending time T2 is not exceeded.

13. The UE of claim 12, in response to a determination that the ending time T2 is exceeded when performing the handover operation, maintaining connection on a channel between the UE and the first base station in the serving cell or quitting handover operation to perform Radio Resource Control (RRC) re-establishment.

14. The UE of claim 11, wherein the processor is further configured to:
in response to a determination that the additional condition is not met, maintain connection on a channel between the UE and the first base station in the serving cell.

15. The UE of claim 11, wherein the processor is further configured to:
receive a configuration from the first base station, wherein the configuration indicates the operation order between testing the channel quality condition and testing the additional condition.

16. A non-transitory computer-readable medium storing instructions that, when executed by a processor of a user equipment (UE), cause the UE to perform operations, the operations comprising:
receiving a message including a conditional handover instruction to perform a handover operation from a first base station in a serving cell to a second base station in a target cell, wherein the conditional handover instruction includes a channel quality condition for the handover operations and an additional condition for the handover operation, and wherein the first base station and the second base station are in a non-terrestrial wireless network (NTN);
determining an operation order between testing the channel quality condition and testing the additional condition;
performing measurement operations to measure quality of a channel between the UE and the second base station in the target cell to test the channel quality condition;
determining whether the channel quality condition is met based on the measurement operations;
determining whether the additional condition is met; and
in response to a determination that the channel quality condition is met and a determination that the additional condition is met, performing the handover operation to handover the UE from the first base station to the second base station.

17. The non-transitory computer-readable medium of claim 16, wherein the operation order indicates testing the channel quality condition is performed before testing the additional condition.

18. The non-transitory computer-readable medium of claim 16, wherein the additional condition is a time condition indicating a starting time T1 and an ending time T2 to perform the handover operation during a time range from T1 to T2, and the determining whether the additional condition is met comprises testing the starting time T1 is met and testing the ending time T2 is not exceeded.

19. The method of claim 18, in response to a determination that the ending time T2 is exceeded when performing the handover operation, maintaining connection on a channel between the UE and the first base station in the serving cell or quitting handover operation to perform Radio Resource Control (RRC) re-establishment.

20. The non-transitory computer-readable medium of claim 16, wherein the operations further comprising:
in response to a determination that the additional condition is not met, maintaining connection on a channel between the UE and the first base station in the serving cell.
